(19) United States
(12) Patent Application Publication
(10) Pub. No.: US 2026/0052617 A1
(43) Pub. Date: Feb. 19, 2026

(54) LIGHTING CONTROL DEVICE WITH AIR GAP SWITCH CONTROLLED OUTPUT

(71) Applicant: SIGNIFY HOLDING B.V., EINDHOVEN (NL)

(72) Inventors: SREENIVAS REDDY KALATHOOR, DULUTH, GA (US); TRAVIS JAMES MCAFEE, PEACHTREE CITY, GA (US); SETH DAVID DOHENY, NEWNAN, GA (US); PHILIP DEAN WINTERS, CENTRE, AL (US)

(21) Appl. No.: 19/104,264

(22) PCT Filed: Aug. 8, 2023
(86) PCT No.: PCT/EP2023/071885

§ 371 Date: Feb. 17, 2025

Related U.S. Application Data
(60) Provisional application No. 63/399,600, filed on Aug. 19, 2022.

(30) Foreign Application Priority Data
Sep. 1, 2022 (EP) 22193478.9

(51) Int. Cl. H05B 47/21; H05B 45/10; H05B 45/31; H05B 47/175; H05B 47/19

(52) U.S. Cl. CPC H05B 47/21; H05B 45/10; H05B 45/31; H05B 47/196; H05B 47/19

(57) ABSTRACT

A lighting control device includes a lighting control circuit and an air gap switch electrically connected to the lighting control circuit. When the air gap switch is closed, the lighting control circuit is configured to provide a controlled output power at a first output terminal of the lighting control device based on an input power received by the air gap switch via an input terminal of the lighting control device. The air gap switch is electrically connected to a second output terminal of the lighting control device such that, when the air gap switch is closed, a bypass output power is provided via the second output terminal independent of the lighting control circuit.

### TECHNICAL FIELD

The present disclosure relates generally to lighting system solutions, and more particularly to lighting control devices with air gap switched controlled output.

### BACKGROUND

Some lighting control devices, such as some dimmers and electronic switches, do not have a physical isolation even when the devices are turned off. Thus, changing a light source or other components of a light fixture that receives electrical power from or through such a lighting control device poses risks of electrical shock, component damage, etc. To avoid such problems, some lighting control devices may include an air gap switch, and light fixtures that receive power controlled by such lighting control devices may be safely operated on by turning off the air gap switch. However, some smart light fixtures are not physically wired to such lighting control devices, and safely changing the light source or other components of such smart light fixtures may require power (e.g., mains power) from a primary power source to be turned off, for example, at a circuit breaker. However, such an action can cause an excessively wide power disruption to many other light fixtures and non-lighting devices, such as other electronic appliances. Thus, a solution that limits wide power disruption to lighting devices and non-lighting devices may be desirable.

### SUMMARY

The present disclosure relates generally to lighting system solutions, and more particularly to lighting control devices with air gap switched controlled output. In an example embodiment, a lighting control device includes a lighting control circuit and an air gap switch electrically connected to the lighting control circuit. When the air gap switch is closed, the lighting control circuit is configured to provide a controlled output power at a first output terminal of the lighting control device based on an input power received by the air gap switch via an input terminal of the lighting control device. The air gap switch is electrically connected to a second output terminal of the lighting control device such that, when the air gap switch is closed, a bypass output power is provided via the second output terminal independent of the lighting control circuit.

In another example embodiment, a lighting system includes a first light device, a second light device, and a lighting control device. The lighting control device includes a lighting control circuit and an air gap switch electrically connected to the lighting control circuit. When the air gap switch is closed, the lighting control circuit is configured to provide a controlled output power at a first output terminal of the lighting control device based on an input power received by the air gap switch via an input terminal of the lighting control device. The air gap switch is electrically connected to a second output terminal of the lighting control device such that, when the air gap switch is closed, a bypass output power is provided via the second output terminal independent of the lighting control circuit.

These and other aspects, objects, features, and embodiments will be apparent from the following description and the appended claims.

### BRIEF DESCRIPTION OF THE FIGURES

Reference will now be made to the accompanying drawings, which are not necessarily drawn to scale, and wherein:

FIG. 1 illustrates a lighting system that includes a lighting control device according to an example embodiment;

FIG. 2 illustrates the lighting control device of FIG. 1 including an electronic switch according to an example embodiment;

FIG. 3 illustrates the lighting control device of FIG. 1 including a dimmer circuit according to an example embodiment; and

FIG. 4 illustrates details of the lighting control device of FIG. 3 according to an example embodiment.

The drawings illustrate only example embodiments and are therefore not to be considered limiting in scope. The elements and features shown in the drawings are not necessarily to scale, emphasis instead being placed upon clearly illustrating the principles of the example embodiments. Additionally, certain dimensions or placements may be exaggerated to help visually convey such principles. In the drawings, the same reference numerals used in different drawings may designate like or corresponding but not necessarily identical elements.

### DETAILED DESCRIPTION OF THE EXAMPLE EMBODIMENTS

In the following paragraphs, example embodiments will be described in further detail with reference to the figures. In the description, well known components, methods, and/or processing techniques are omitted or briefly described. Furthermore, reference to various feature(s) of the embodiments is not to suggest that all embodiments must include the referenced feature(s).

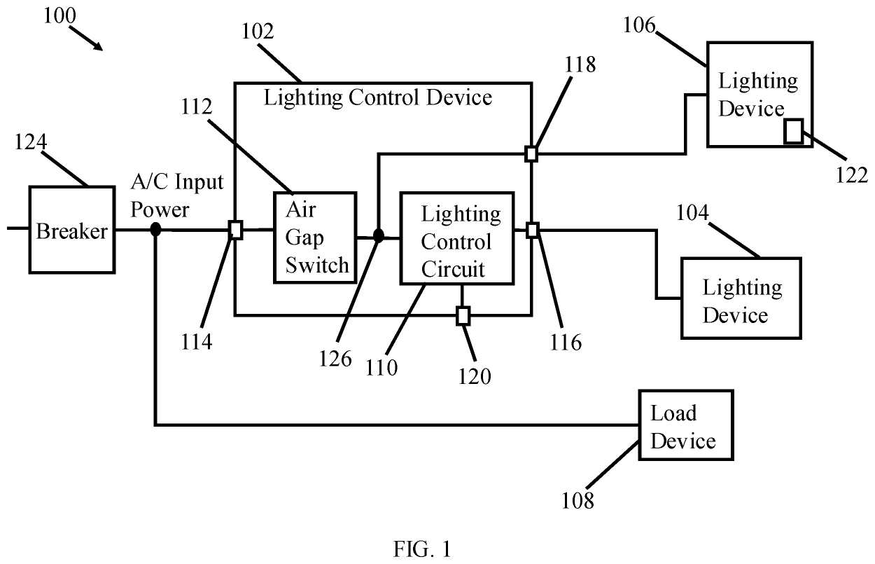

FIG. 1 illustrates a lighting system 100 that includes a lighting control device 102 according to an example embodiment. In some example embodiments, the lighting system 100 includes the lighting control device 102, a lighting device 104, and a smart lighting device 106. For example, the lighting device 104 and the smart lighting device 106 may be in the same lighting area, group, and/or zone. The lighting system 100 may also include a load device 108 and a circuit breaker 124. The load device 108 may be an electrical appliance, a light fixture, or another electrical device. The lighting control device 102 may be electrically connected (i.e., connected by one or more electrical wires and, optionally, electrical components) to the circuit breaker 124. For example, the lighting control device 102 may include an input terminal 114 that is electrically connected to the circuit breaker 124 by electrical wires. The input terminal 114 may be or may include end portions (e.g., exposed/uninsulated end portion) of electrical wires and/or electrical connectors. For example, the input terminal 114 may include one or more screw terminals and/or push-in terminals. As another example, the input terminal 114 may include one or more electrical connectors that are attached (e.g., soldered) to a printed circuit board, where one or more other components of the lighting control device 102 are also attached to the printed circuit board. As another example, the input terminal 114 may be the ‘input’ terminal of the air gap switch 112. In some example embodiments, the lighting control device 102 may be inside a housing, and the input terminal 114 may be partially or entirely inside, on, or outside the housing. The lighting control device 102 and the load device 108 may receive alternating-current (A/C) input power (e.g., mains power) through the circuit breaker 124 unless the A/C input power is turned off at the circuit breaker 124. The A/C input power may be provided to the lighting control device 102 and the load device 108 at 120 V AC or at another suitable voltage.

In some example embodiments, the lighting control device 102 may include an air gap switch 112 and a lighting control circuit 110. The air gap switch 112 may be electrically connected to the input terminal 114 and to the lighting control circuit 110. For example, when the air gap switch 112 is closed (i.e., on) to allow electrical current to pass therethrough, the lighting control circuit 110 may operate based on the A/C input power received via the input terminal 114. To illustrate, the lighting control circuit 110 may be electrically connected to an output terminal 116 of the lighting control device 102 and, when the air gap switch 112 is closed, the lighting control circuit 110 may provide a controlled output power (i.e., controlled electrical power) via the output terminal 116 based on the A/C input power received via the input terminal 114. When the air gap switch 112 is open (i.e., off), the controlled output power provided by the lighting control circuit 110 via the output terminal 116 is off and thus unavailable. The controlled output power provided by the lighting control circuit 110 via the output terminal 116 may also depend on one or more user inputs provided to the lighting control device 102.

To illustrate, in some example embodiments, the lighting control device 102 may include a user interface 120, and the lighting control device 102 may receive user inputs via the user interface 120. A user, such as a contractor or a consumer, may use the user interface 120 to provide inputs to the lighting control device 102. For example, the user interface 120 may be a dimmer slider or knob, a touch screen interface, a push-button switch, a wireless and/or wired communication unit that can communicate with a user control device (e.g., mobile phone), or another type of user interface as can be readily understood by those of ordinary skill in the art with the benefit of this disclosure.

In some example embodiments, the lighting control circuit 110 may be or may include a dimmer (e.g., a TRIAC dimmer), and the controlled output power provided by the lighting control circuit 110 via the output terminal 116 may be used for lighting device dimming control. The controlled power provided by the lighting control circuit 110 may depend on one or more user inputs provided via the user interface 120. For example, a user may provide a dim level setting to the lighting control circuit 110 via the user interface 120, and the controlled output power provided by the lighting control circuit 110 via the output terminal 116 may depend on the dim level setting. In some alternative embodiments, the lighting control circuit 110 may be or may include an electronic switch, such as a solid-state switch, instead of or in addition to a dimmer circuit and, whether the lighting control circuit 110 provides the controlled output power via the output terminal 116 may depend on an on/off user input provided to the electronic switch via the user interface 120.

In some example embodiments, the air gap switch 112 may be physically connected to the output terminal 118 of the lighting control device 102 mechanically (e.g., soldering or a screw) or by one or more wires. The air gap switch 112 may be electrically connected (e.g., by one or more electrical wires and/or electrical components) to the output terminal 118 of the lighting control device 102. For example, one of an electrical cable may be connected to the output terminal 118, and another end of the electrical cable may be directly connected to an “output” terminal of the air gap switch 112 or may be spliced (e.g., at an electrical node 126) with an electrical cable connecting the “output” terminal of the air gap switch 112 with the lighting control circuit 110. When the air gap switch 112 is closed (i.e., on) to allow electrical current to pass therethrough, the lighting control device 102 may provide output power (i.e., bypass output power) via the output terminal 118 based on the A/C input power. For example, when the air gap switch 112 is closed, the input terminal 114 of the lighting control device 102 may be effectively the same electrical node as the output terminal 118. That is, unlike the controlled output power provided by the lighting control circuit 110 via the output terminal 116, the bypass output power provided via the output terminal 118 may be independent of (i.e., not controlled by) the lighting control circuit 110 and user inputs provided to the lighting control circuit 110. When the air gap switch 112 is open (i.e., off), the bypass output power provided by the lighting control device 102 via the output terminal 118 is off and thus unavailable. The air gap switch 112 may be opened and closed by a user as can be readily understood by those of ordinary skill in the art with the benefit of this disclosure.

In some example embodiments, the lighting control device 102 may include the output terminals 116, 118. The output terminal 116 may be or may include exposed end portions of one or more electrical wires and/or one or more electrical connectors. For example, the output terminal 116 may include one or more screw terminals and/or push-in terminals attached to and terminating one or more electrical wires. As another example, the output terminal 116 may include one or more electrical connectors that are attached (e.g., soldered) to a printed circuit board, where one or more other components of the lighting control device 102 are also attached to the printed circuit board. In some example embodiments, the lighting control device 102 may be inside a housing, and the output terminal 116 may be partially or entirely inside, on, or outside the housing. The output terminal 118 may also include exposed end portions of one or more electrical wires and/or one or more electrical connectors. For example, the output terminal 118 may include one or more screw terminals and/or push-in terminals attached to and terminating one or more electrical wires. As another example, the output terminal 118 may include one or more electrical connectors that are attached (e.g., soldered) to a printed circuit board, where one or more other components of the lighting control device 102 are also attached to the printed circuit board. As yet another example, the output terminal 118 may be the ‘output’ terminal of the air gap switch 112. In some example embodiments, the lighting control device 102 may be inside a housing, and the output terminal 118 may be partially or entirely inside, on, or outside the housing.

In some example embodiments, the lighting control device 102 may be electrically connected to the lighting device 104. The lighting device 104 may operate using electrical power (i.e., the controlled output power) received from the lighting control circuit 110. For example, the lighting device 104 may be a light emitting diode (LED) light fixture that includes an integrated driver or an external driver that is electrically connected to the output terminal 116 of the lighting control device 102. The lighting device 104 may be electrically connected to the output terminal 116 by an electrical cable (e.g., one or more electrical wires). For example, the electrical cable may be a part of a building electrical wiring. As described above, the lighting control circuit 110 may include a dimmer (e.g., a TRIAC dimmer) and/or an electronic switch, and the controlled output power provided to the lighting device 104 by the lighting control device 102 via the output terminal 116 may be electrical power that is controlled by the dimmer and/or by the electronic switch (e.g., a solid-state switch).

In some example embodiments, the lighting control device 102 may be electrically connected to the smart lighting device 106. The smart lighting device 106 may be electrically connected to the output terminal 118 by an electrical cable (e.g., one or more electrical wires), where the electrical cable may be a part of a building electrical wiring. The smart lighting device 106 may operate using the bypass output power received from the lighting control device 102 via the output terminal 118 of the lighting control device 102. To illustrate, the bypass output power is available to the lighting device 106 via the output terminal 118 when the air gap switch 112 is closed. When the air gap switch 112 is open (i.e., off), the bypass output power is off and thus unavailable to the lighting device 106 via the output terminal 118.

In some example embodiments, the smart lighting device 106 may be an LED light fixture that can be wirelessly controlled by a user to turn on and off the light provided by the smart lighting device 106, to change intensity of the light, etc. To illustrate, the smart lighting device 106 may include a wireless and/or wired communication module 122 that can receive lighting control instructions that are sent to control the smart lighting device 106. For example, the communication module 122 may receive wireless signals that are compliant with, for example, one or more of Wi-Fi, BLE, ZigBee, etc. wireless protocols. In some alternative embodiments, the smart lighting device 106 may be controlled through other means as can be readily understood by those of ordinary skill in the art with the benefit of this disclosure.

By providing the controlled power from the lighting control circuit 110 to the lighting device 104 and by providing the bypass output power to the lighting device 106 independent of the lighting control circuit 110, the lighting control device 102 can provide power to the lighting devices separately. When a person wants to change a light source or another component of the lighting device 106, the person can turn off the power provided to the lighting device 106 by turning off the air gap switch 112 to disconnect the bypass output power from the output terminal 118. If the lighting device 106 connected to receive power directly through the breaker 124 instead of the lighting control device 102, changing a component of the lighting device 106 would require the A/C input power to be disconnected at the circuit breaker 124, which can lead to a wide disruption of power to other devices such as the load device 108. Providing the bypass output power to the lighting device 106 and the capability to disconnect the bypass output power from the lighting device 106 by using of the air gap switch 112 can avoid power disruptions to other devices such as the load device 108 by avoiding the need to turn off the AC input power at the circuit breaker 124. In some cases, because an air gap switch, such as the air gap switch 112, is required to be used with some light dimmer devices to meet certification standards (e.g., a UL standard), providing the bypass output power can be achieved with minimal additional cost.

In some alternative embodiments, the lighting control device 102 may include other components than shown without departing from the scope of this disclosure. In some alternative embodiments, the lighting system 100 may include more load devices than shown without departing from the scope of this disclosure. In some alternative embodiments, the lighting devices 104, 106 may be non-LED light fixtures without departing from the scope of this disclosure. In some example embodiments, the lighting device 106 may be a non-lighting device without departing from the scope of this disclosure. In some alternative embodiments, the lighting system 100 may include more lighting devices than shown without departing from the scope of this disclosure. For example, the output terminal 116 may be electrically connected to two or more lighting devices, and the output terminal 118 may be electrically connected to two or more lighting devices. In some alternative embodiments, the lighting control device 102 may include other terminals or interfaces than shown without departing from the scope of this disclosure. In some example embodiments, the A/C input power may be provided by a power company or may be derived from location equipment such as a solar power source, etc.

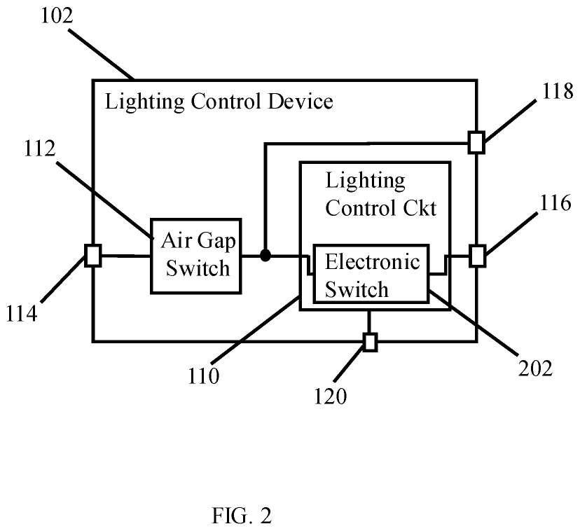

FIG. 2 illustrates the lighting control device 102 of FIG. 1 including an electronic switch 202 according to an example embodiment. Referring to FIGS. 1 and 2, as described above with respect to FIG. 1, the lighting control device 102 includes the lighting control circuit 110 and the air gap switch 112. The lighting control device 102 may also include the input terminal 114, the output terminals 116, 118, and the user interface 120. The lighting control circuit 110 may include the electronic switch 202 (e.g., a solid-state switch) that can be turned on and off based on user inputs provided to the lighting control circuit 110 via the user interface 120.

In some example embodiments, when the air gap switch 112 is closed (i.e., on), the lighting control circuit 110 may provide the controlled output power via the output terminal 116 if the electronic switch 202 is on. The controlled output power may be turned off or otherwise unavailable at the output terminal 116 if the electronic switch 202 is turned off even when the air gap switch 112 is closed. If the air gap switch 112 is open (i.e., off), the controlled output power provided at the output terminal 116 may be turned off or otherwise unavailable regardless of user input(s) provided via the user interface 120 to control the electronic switch 202. The air gap switch 112 may be used with the electronic switch 202, for example, to mitigate the inherent risk (e.g., electric shock) associated with electronic switches and light devices that received power through by an electronic switch.

As described above with respect to FIG. 1, when the air gap switch 112 is closed, the bypass output power is available via the output terminal 118 that is electrically connected to the air gap switch 112. When the air gap switch 112 is open (i.e., off), the bypass output power is off and thus unavailable at the output terminal 118. The bypass output power is made available or unavailable at the output terminal 118 independent of the lighting control circuit 110.

In some alternative embodiments, the lighting control circuit 110 may include components other than shown in FIG. 2 without departing from the scope of this disclosure. In some alternative embodiments, the lighting control device 102 may include components other than shown in FIG. 2 without departing from the scope of this disclosure.

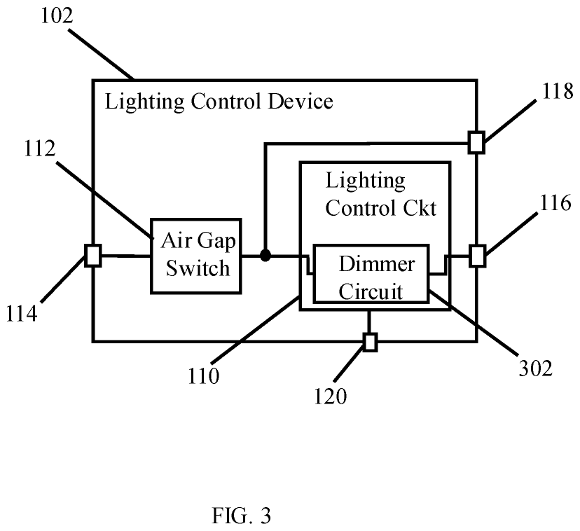

FIG. 3 illustrates the lighting control device 102 of FIG. 1 including a dimmer circuit 302 according to an example embodiment. Referring to FIGS. 1 and 3, as described above with respect to FIG. 1, the lighting control device 102 includes the lighting control circuit 110 and the air gap switch 112. The lighting control device 102 may also include the input terminal 114, the output terminals 116, 118, and the user interface 120. The lighting control circuit 110 may include the dimmer circuit 302 (e.g., a TRIAC dimmer) that can be operated (e.g., dim level set) by user inputs provided to the lighting control circuit 110 via the user interface 120. For example, the user interface 120 may be a dimmer slider or knob.

In some example embodiments, when the air gap switch 112 is closed (i.e., on), the dimmer circuit 302 may provide the controlled output power via the output terminal 116, where the amount of power may depend on dim level setting provided to the lighting control circuit 110 via the user interface 120. If the air gap switch 112 is open (i.e., off), the controlled output power provided by the dimmer circuit 302 at the output terminal 116 may be turned off or otherwise unavailable regardless of user input(s) provided via the user interface 120 to control the dimmer circuit 302. The air gap switch 112 may be used with the dimmer circuit 302, for example, to mitigate the inherent risk (e.g., electric shock) associated with dimmer circuits and light devices controlled by a dimmer circuit.

As described above with respect to FIG. 1, when the air gap switch 112 is closed, the bypass output power is available via the output terminal 118 that is electrically connected to the air gap switch 112. When the air gap switch 112 is open (i.e., off), the bypass output power is off and thus unavailable at the output terminal 118. The bypass output power is made available or unavailable at the output terminal 118 independent of the lighting control circuit 110.

In some alternative embodiments, the lighting control circuit 110 may include components other than shown in FIG. 3 without departing from the scope of this disclosure. In some alternative embodiments, the lighting control device 102 may include components other than shown in FIG. 3 without departing from the scope of this disclosure.

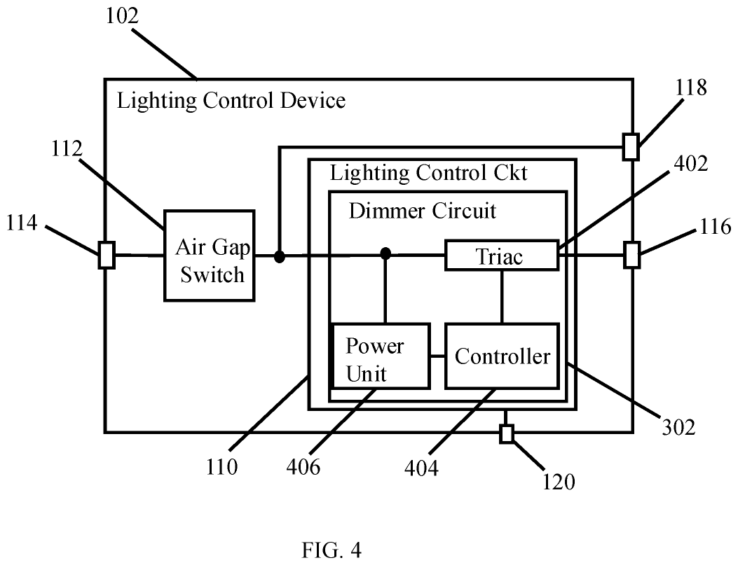

FIG. 4 illustrates details of the lighting control device 102 of FIG. 3 according to an example embodiment. Referring to FIGS. 1, 3, and 4, in some example embodiments, the lighting control circuit 110 includes the dimmer circuit 302. The dimmer circuit 302 may include a TRIAC 402, a controller 404, and a power unit 406. For example, the power unit 406 may include one or more voltage regulators that receive AC power through the air gap switch 112 and provide a voltage compatible with the controller 404 when the air gap switch 112 is closed. To illustrate, the controller may include a microcontroller and one or more memory devices (e.g., static random access memory and/or flash memory), where the microcontroller executes software code stored in the one or more memory devices as can be readily understood by those of ordinary skill in the art with the benefit of this disclosure.

In some example embodiments, the controller 404 may receive user inputs (e.g., dimmer setting information) via the user interface 120 and control the TRIAC 402 to control the controlled output power provided via the output terminal 116. To illustrate, when the air gap switch 112 is closed (i.e., on), the dimmer circuit 302 may provide the controlled output power via the output terminal 116, where the amount of power may depend on dim level setting provided to the controller 404 via the user interface 120. If the air gap switch 112 is open (i.e., off), the controlled output power provided by the dimmer circuit 302 at the output terminal 116 may be turned off or otherwise unavailable regardless of dimmer setting information provided via the user interface 120.

In some alternative embodiments, the dimmer circuit 302 may be another type of dimmer circuit instead of a TRIAC dimmer circuit without departing from the scope of this disclosure. In some alternative embodiments, the dimmer circuit 302 may include other components than shown without departing from the scope of this disclosure.

Although particular embodiments have been described herein in detail, the descriptions are by way of example. The features of the example embodiments described herein are representative and, in alternative embodiments, certain features, elements, and/or steps may be added or omitted. Additionally, modifications to aspects of the example embodiments described herein may be made by those skilled in the art without departing from the scope of the following claims, the scope of which are to be accorded the broadest interpretation so as to encompass modifications and equivalent structures.

1. A lighting control device comprising:
a lighting control circuit; and
an air gap switch electrically connected to the lighting control circuit, wherein, when the air gap switch is closed, the lighting control circuit is configured to provide a controlled output power at a first output terminal of the lighting control device based on an input power received by the air gap switch via an input terminal of the lighting control device and wherein the air gap switch is electrically connected to a second output terminal of the lighting control device such that, when the air gap switch is closed, a bypass output power is provided via the second output terminal independent of the lighting control circuit, and wherein a load electrically connected to the second output terminal is not controlled by the lighting control circuit.

2. The lighting control device of claim 1, wherein the lighting control circuit includes an electronic switch.

3. The lighting control device of claim 1, wherein the lighting control circuit includes a dimmer circuit.

4. The lighting control device of claim 3, wherein the dimmer circuit includes a TRIAC.

5. The lighting control device of claim 1, wherein the controlled output power depends on a user input received by the lighting control circuit via a user input interface of the lighting control device.

6. The lighting control device of claim 1, wherein the air gap switch is electrically connected to the input terminal and to the second output terminal.

7. The lighting control device of claim 1, wherein one or more of the input terminal, the first output terminal, and the second output terminal are an end portion of one or more electrical wires or one or more electrical connectors.

8. The lighting control device of claim 1, wherein the second output terminal includes an electrical connector terminating one or more electrical wires.

9. A lighting system, comprising:
a first light device;
a second light device; and
a lighting control device, comprising:
a lighting control circuit; and
an air gap switch electrically connected to the lighting control circuit, wherein, when the air gap switch is closed, the lighting control circuit is configured to provide a controlled output power at a first output terminal of the lighting control device based on an input power received by the air gap switch via an input terminal of the lighting control device, wherein the air gap switch is electrically connected to a second output terminal of the lighting control device such that, when the air gap switch is closed, a bypass output power is provided via the second output terminal independent of the lighting control circuit, wherein the first light device is coupled to the first output terminal, and wherein the second light device is coupled to the second output terminal, wherein a load electrically connected to the second output terminal is not controlled by the lighting control circuit.

10. The lighting system of claim 9, wherein the lighting control circuit includes an electronic switch.

11. The lighting system of claim 9, wherein the lighting control circuit includes a dimmer circuit.

12. The lighting system of claim 11, wherein the dimmer circuit includes a TRIAC.

13. The lighting system of claim 9, wherein the controlled output power depends on a user input received by the lighting control circuit via a user input interface of the lighting control device.

14. The lighting system of claim 9, wherein the air gap switch is electrically connected to the input terminal and to the second output terminal.

15. The lighting system of claim 9, wherein the second light device is a smart lighting fixture.
